(19) United States
(12) Patent Application Publication
(10) Pub. No.: US 2013/0147078 A1
(43) Pub. Date: Jun. 13, 2013

(54) MOLDING MACHINE CONTROLLING APPARATUS AND METHOD OF CONTROLLING MOLDING MACHINE

(71) Applicant: Toshiba Kikai Kabushiki Kaisha, Tokyo (JP)

(72) Inventors: Haruyuki MATSUBAYASHI, Numazu-shi (JP); Harumichi TOKUYAMA, Odawara-shi (JP); Takeshi IIDA, Numazu-shi (JP)

(73) Assignee: TOSHIBA KIKAI KABUSHIKI KAISHA, Tokyo (JP)

(21) Appl. No.: 13/711,100

(22) Filed: Dec. 11, 2012

(30) Foreign Application Priority Data
Dec. 12, 2011 (JP) 2011-271552
Oct. 22, 2012 (JP) 2012-232777

(51) Int. Cl. B29C 45/77

(52) U.S. Cl. CPC B29C 45/77
USPC 264/40.3; 425/149

(57) ABSTRACT

A pressure detector which detects a pressure of a material in a cylinder, and a pressure compensator which compares, in injection control, a preset value of an injection pressure with an actual measurement value of the injection pressure detected by the pressure detector, generates an injection speed command to a servo motor based on a comparison value, and varies a proportional gain based on a deviation of the actual measurement value of the injection pressure from the preset value of the injection pressure.

### CROSS-REFERENCE TO RELATED APPLICATIONS

This application is based upon and claims the benefit of priority from prior Japanese Patent Applications No. 2011-271552, filed Dec. 12, 2011; and No. 2012-232777, filed Oct. 22, 2012, the entire contents of all of which are incorporated herein by reference.

### BACKGROUND OF THE INVENTION

1. Field of the Invention

Embodiments described herein relate generally to a molding machine controlling apparatus, in particular, a technique of enabling smooth injection pressure response.

2. Description of the Related Art

In injection control of a molding machine using a servo motor as a driving mechanism, either of speed control of controlling the injection speed and pressure control of controlling the pressure is used. The speed control is performed by detecting the number of rotations of the servo motor by a speed sensor, and performing feedback control for the injection speed set value based on the detected value. The pressure control is performed by detecting pressure by a load cell which detects reaction force applied onto the injection screw or a resin pressure sensor provided on a tip of the nozzle, and performing feedback control for the set injection pressure based on the detected value (for example, see Jpn. Pat. Appln. KOKAI Pub. No. 1-263021). It is generally adopted to perform speed control in which the actual injection pressure is sufficiently smaller than the set injection pressure, and perform pressure control in which the actual injection pressure is close to or larger than the set injection pressure. In feedback control performed in pressure control, pressure compensation is performed with a control gain determined in consideration of the responsiveness.

Responsiveness of injection in injection molding differs according to the shape of molding products, the material of molding products, and the molding conditions. When the actual injection pressure in a filling area in the injection process is sufficiently smaller than the set pressure, the injection pressure increases while the cavity in the mold is filled with the molten material, and thus response of the injection pressure for the injection speed is low. On the other hand, when the actual injection pressure in the filling area in the injection process is close to or larger than the set pressure, filling of the material into the cavity in the mold has almost been finished or has been finished, and thus response of the injection pressure for the injection speed is high. Therefore, in prior art, the control gain is changed for the speed control and the pressure control, to deal with the difference in responsiveness.

There are the cases, however, where injection response rapidly changes when the speed control is switched to the pressure control. FIG. 5 is a graph which illustrates such an example. In FIG. 5, V denotes the actual injection speed, V0 denotes the set injection speed, P denotes the actual injection pressure, P0 denotes the set injection pressure, and T denotes the timing of switching the control gain. The direction going from the right to the left indicates the right direction of the injection screw position. Suppose that the speed control is performed first, and the injection speed is fixed at the time when the actual injection speed V reaches the set injection speed V0. Next, although the control gain is changed at the time when the actual injection pressure P comes close to the set injection pressure P0 (switching timing T), overshoot (the actual injection pressure P exceeds the set injection pressure P0) of the injection pressure occurs due to inertia of the servo motor and the rotational force transmission mechanism (α in FIG. 5). Therefore, control to reduce the actual injection speed V is performed to lower the actual injection pressure P (β in FIG. 5), and the injection speed is rapidly reduced. When the injection speed is rapidly changed as described above, unexpected pressure is applied to the material which has been injected into the cavity in the mold, and there are cases where precisive molding cannot be performed.

In addition, when a proper control gain is not set, there is the problem that response of the injection pressure fluctuates (the pressure repeatedly increases and decreases for a short time), and precisive molding cannot be performed.

To deal with such defects, various techniques have been developed. For example, there is disclosed a technique in which a command value of the screw moving speed to remove the difference in pressure is determined based on the difference between the set resin pressure and the detected resin pressure, the command value is set as the command speed when the command value falls within the preset speed limit range, and the set speed limit is set as the command speed when the command value falls out of the speed limit range (for example, see Jpn. Pat. Appln. KOKAI Pub. No. 5-278089). In addition, there is disclosed a technique in which the pressure set value of the injection pressure is compared with the detected pressure value of the injection pressure, a speed command is generated based on the comparison value, and the value of the control gain is variably controlled (for example, see Jpn. Pat. Appln. KOKAI Pub. No. 2003-340899).

The molding machines controlling apparatus described above have the following problems. Specifically, the technique disclosed in Jpn. Pat. Appln. KOKAI Pub. No. 5-278089 has the problem that the control gain have to be reduced to prevent overshoot, the time required for reaching the set injection pressure increases when the actual injection pressure is sufficiently smaller than the set injection pressure, and thus the molding time increases. In addition, in the technique disclosed in Jpn. Pat. Appln. KOKAI Pub. No. 2003-340899, it is unclear what variable control of the value of the control gain generates the optimum gain. Therefore, the technique has the problem that proper injection pressure response is not achieved in injection molding, and precisive molding cannot be performed.

### BRIEF SUMMARY OF THE INVENTION

Therefore, the present invention is aimed at providing a molding machine controlling apparatus and a molding machine controlling method, which use an optimum control gain when pressure compensation is performed based on a deviation of the actual injection pressure from the set injection pressure, and thereby enables smooth injection pressure response.

To solve the above problem and achieve the object, the molding machine controlling apparatus and the molding machine controlling method of the present invention have the following structure.

A controlling apparatus for a molding machine which advances and retreats an extruded member by a driving mechanism and performs injection, comprises: a pressure detector which detects a pressure of a material in a cylinder; and a pressure compensator which compares, in injection control, a preset value of an injection pressure with an actual measurement value of the injection pressure detected by the pressure detector, generates an injection speed command to the driving mechanism based on a comparison value, and varies a proportional gain based on a deviation of the actual measurement value of the injection pressure from the preset value of the injection pressure.

A method of controlling a molding machine which advances and retreats an extruded member by a driving mechanism and performs injection, comprises: detecting a pressure of a material in a cylinder; comparing, in injection control, a preset value of an injection pressure with an actual measurement value of the injection pressure detected by the detecting; compensating pressure by generating an injection speed command to the driving mechanism based on an obtained comparison value; and varying a proportional gain based on a deviation of the actual measurement value of the injection pressure from the preset value of the injection pressure.

According to the present invention, an optimum control gain is used when pressure compensation is performed based on a deviation of the actual injection pressure (actual measurement value of the injection pressure) from the set injection pressure (set value of the injection pressure), and thereby smooth injection pressure response can be achieved.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating an injection molding machine including an injection molding machine controlling apparatus according to a first embodiment of the present invention.

FIG. 2 is a block diagram illustrating a detailed operation process in a pressure compensator which is included in a pressure control module of the injection molding machine.

FIG. 3 is a graph illustrating setting of a proportional gain for a reference material in the pressure compensator.

FIG. 4 is a graph illustrating injection waveforms generated by the injection molding machine.

FIG. 5 is a graph illustrating injection waveforms generated by a common injection molding machine.

FIG. 6 is a graph illustrating relation between the actual injection speed and the pressure gradient in various materials used in a controlling method according to a second embodiment of the present invention.

FIG. 7 is a graph illustrating changes with the lapse of time of the filling pressure, the switching pressure from the speed control to the pressure control, and the proportional gain in the controlling method according to the second embodiment of the present invention.

FIG. 8 is a graph illustrating setting of the proportional gain in the case where the pressure gradient of the filling material is larger than the pressure gradient in a reference material.

FIG. 9 is a graph illustrating setting of the proportional gain in the case where the pressure gradient of the filling material is smaller than the pressure gradient in a reference material.

### DETAILED DESCRIPTION OF THE INVENTION

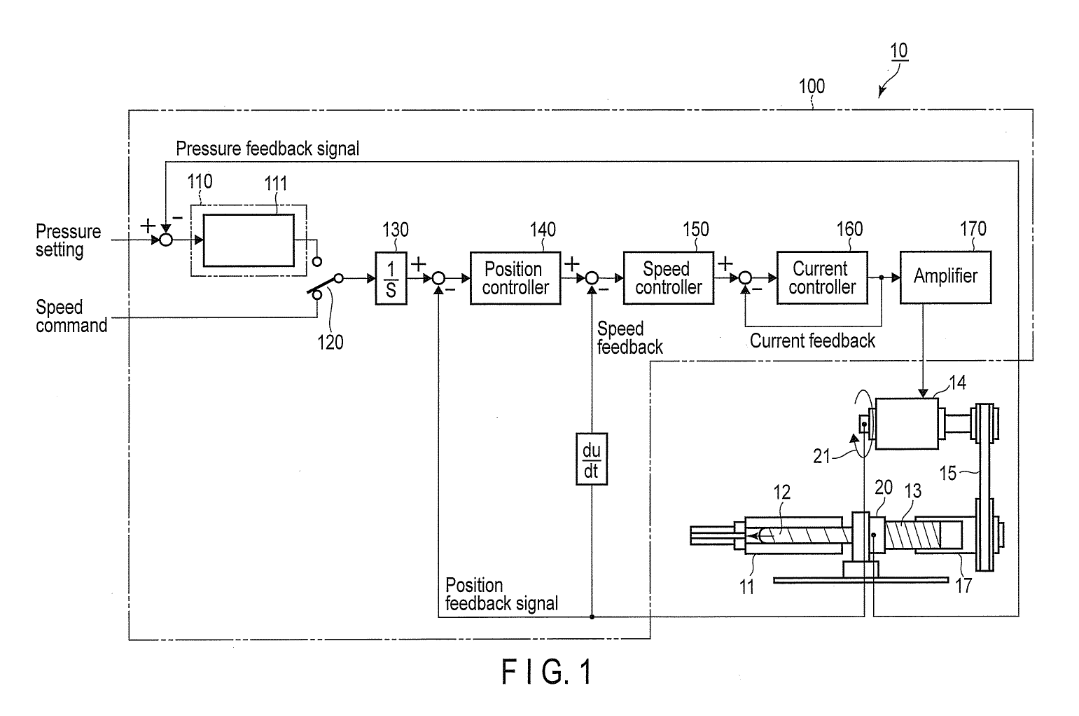

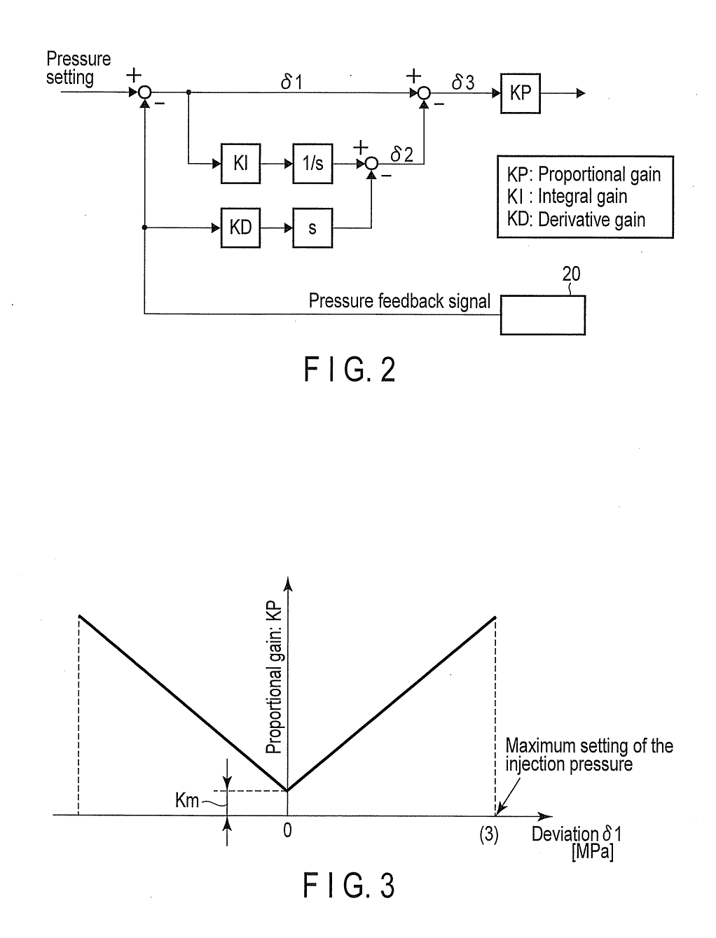

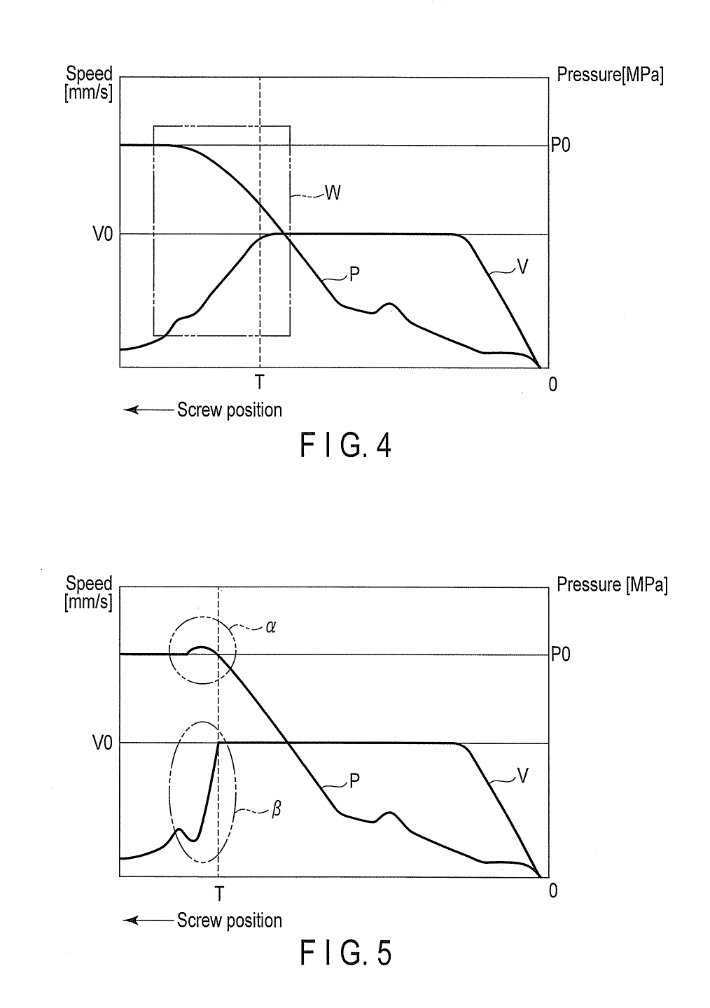

FIG. 1 is a block diagram illustrating an injection molding machine 10 including an injection molding machine controlling apparatus 100 according to a first embodiment of the present invention, FIG. 2 is a block diagram illustrating a detailed operation process in a pressure compensator 111 which is included in the injection molding machine controlling apparatus 100, FIG. 3 is a graph illustrating setting of a proportional gain in a pressure compensator 111, and FIG. 4 is a graph illustrating injection waveforms generated by the injection molding machine 10.

The injection molding machine 10 comprises a cylinder 11, a screw (extruded member) 12 configured to mix, pressurize, and inject a material (such as resin, glass, metal, carbon fiber, compound thereof, and mixture thereof) in the cylinder 11, a ball screw 13 configured to advance or retreat the screw 12, a servo motor 14 configured to rotate the ball screw 13, a transmission mechanism 15 which transmits the rotational force of the servo motor 14 to the ball screw 13, and a controlling apparatus 100 which controls the injection pressure and the injection speed by driving the screw 12 with the servo motor 14. In FIG. 1, reference numeral 20 denotes a pressure detector which detects the pressure applied to the ball screw 13, and reference numeral 21 denotes a sensor which detects the rotational angle (speed) of the servo motor 14. The servo motor 14, the ball screw 13, and the transmission mechanism 15 are part of a driving mechanism.

The controlling apparatus 100 comprises a pressure control module 110, a switch 120 which selects one, which has the smaller value, of a command value in the pressure control and a command value in the speed control, a calculator 130 which converts the selected command value into a position signal, a position controller 140 which converts a deviation of the position signal from a position feedback signal into a speed signal, and controls a position of the screw, a speed controller 150 which determines the rotational speed of the servo motor 14 based on a deviation of the above speed signal from a speed feedback signal obtained by differentiating the position feedback signal, and converts the rotation speed into a current signal, a current controller 160 which generates a driving control signal based on a deviation of the current signal from a current feedback signal, and an amplifier 170 which amplifies the driving control signal and outputs the amplified signal as a driving current. The driving current outputted from the amplifier 170 is inputted to the servo motor 14, and the servo motor 14 is driven and rotated.

The position feedback signal is an actual measurement value of the injection position. The pressure control module 110 includes a pressure compensator 111 which performs pressure compensation by providing a proper control gain based on a deviation of the pressure feedback signal from the set pressure. The pressure feedback signal is the actual measurement value detected by the pressure detector 20.

As illustrated in FIG. 2, the pressure control module 110 uses the deviation of the pressure feedback signal from the pressure setting, that is, compares the set value of the injection pressure with the actual measurement value of the injection pressure detected by the pressure detector, and generates a command value in the pressure control based on the deviation (comparison value). Then, the pressure control module 110 generates an injection position command through the switch 120 and the calculator 130. The pressure control module 110 varies proportional gain KP, based on the deviation of the actual measurement value of the injection pressure from the set value of the injection pressure, as described later.

A deviation δ1 of the pressure feedback signal from the pressure setting is operated with an integral gain KI and integrated, the pressure feedback signal is operated with a derivative gain KD and differentiated, and a deviation δ2 between the operated and integrated deviation δ1 and the operated and differentiated pressure feedback signal is calculated. In addition, a deviation δ3 between the deviation δ1 and the deviation 52 is calculated. The deviation δ3 is operated with the proportional gain KP, and thereby the command value in the pressure control is calculated.

As illustrated in FIG. 3, the proportional gain KP is variably set, based on the deviation δ1. The minimum gain Km is set when the deviation δ1 is 0. The proportional gain KP is increased as the absolute value of the deviation increases from the minimum gain Km. Specifically, it is set such that the proportional gain KP proportionally increases when the absolute value of the deviation δ1 is large.

The deviation δ3 is a value which almost depends on the value of the deviation δ1, and the proportional gain KP is also influenced by the value of the deviation δ1. Therefore, the command signal in the pressure control which is obtained by multiplying the deviation δ3 by the proportional gain KP is greatly influenced by the value of the deviation δ1. In other words, a large pressure signal is outputted when the actual injection pressure is sufficiently smaller than the set injection pressure. On the other hand, a small pressure signal is outputted when the actual injection pressure is close to the set injection pressure. In the case where the actual injection pressure agrees with the set injection pressure, the minimum gain Km serves as the proportional gain KP.

In the injection molding machine control apparatus 100 structured as described above, the injection molding machine 10 is controlled as follows. Specifically, when the command value in the pressure control calculated by the pressure control module 110 is larger than the command value in the speed control, the servo motor 14 is driven by the command value in the speed control and the position feedback signal. When the command value in the pressure control calculated by the pressure control module 110 becomes equal to or lower than the command value in the speed control, the servo motor 14 is driven by the command value in the pressure control and the position feedback signal. The servo motor 14 rotates the ball screw 13 through the transmission mechanism 15. The screw 12 is rotated by the ball screw 13, and the material in the cylinder 11 is injected into the cavity in the mold.

The pressure detector 13 outputs the pressure feedback signal (actual injection pressure), and the sensor 21 outputs the rotational angle (speed) of the servo motor 14 as the position feedback signal.

The deviation δ1 is obtained by comparing the pressure feedback signal with the pressure setting. The deviation δ1 is inputted to the pressure compensator 111, and a signal obtained by multiplying the deviation δ1 by the control gain or the like is outputted as a command signal in the pressure control. Thereafter, the signal is inputted to the position controller 140 through the switch 120 and the calculator 130, and converted into a driving current (injection speed command) to the servo motor 14 in the end.

The command in the speed control is inputted to the position controller 140 through the switch 120 and the calculator 130, and converted into a driving current (injection speed command) to the servo motor 14 in the end.

Next, relation between the actual injection speed V, the set injection speed V0, the actual injection pressure P, and the set injection pressure P0 from start to end of injection will be explained with reference to FIG. 4. Reference symbol T denotes the timing of switching the control gain. In FIG. 4, the direction going from the right to the left indicates the right direction of the screw position.

As illustrated in FIG. 4, feedback control is performed based on the command in the speed control, for a period of time directly after the injection is started. The actual injection speed V is fixed at the time when the actual injection speed V reaches the set injection speed V0. Next, when the actual injection pressure P comes close to the set injection pressure P0, the switch 120 is switched (switching timing T), and feedback control using the pressure is performed.

The deviation 61 is calculated by using the pressure setting and the pressure feedback signal, and inputted to the pressure compensator 111. The pressure compensator 111 performs operation as described above. During the operation, a large pressure signal is outputted when the actual injection pressure P is sufficiently smaller than the set injection pressure P0. Therefore, the rotational speed of the servo motor 14 is maintained at high value, and the increasing speed of the actual injection pressure P is rapid. On the other hand, when the actual injection pressure P comes close to the set injection pressure P0, a small pressure signal is outputted. Therefore, the rotational speed of the servo motor 14 decreases as the actual injection pressure P comes close to the set injection pressure P0, and the increasing speed of the actual injection pressure P becomes slow. Then, the rotational speed of the servo motor 14 becomes very slow at the time when the actual injection pressure P reaches the set injection pressure P0, the injection is finished after the dwelling process is performed, and the molded product is manufactured.

As described above, in before and after the speed control is switched to the pressure control, (that is in region W indicated by a two-dot chain line in FIG. 4), the proportional gain KP is made depend on the deviation δ1 when pressure compensation is performed based on the deviation δ1 of the actual injection pressure from the set injection pressure. Thereby, it is possible to obtain an optimum control gain, and achieve smooth injection pressure response. Therefore, proper injection pressure response is achieved in injection molding, and precisive molding can be performed.

Since the minimum gain Km of the proportional gain KP is set, it is possible to receive influence of I control, suppress fluctuations of the control gain around the set injection pressure, and prevent occurrence of oscillation in response (the pressure is repeatedly increased and decreased for a short time).

In addition, the pressure compensator 111 is provided with a storage module which stores the newest proportional gain, a comparing module which compares a proportional gain that is calculated each time when the deviation δ1 is obtained with the proportional gain stored in the storage module, and uses the smaller proportional gain as a new proportional gain, and an input module which inputs the new control gain to the storage module. Thereby, it is possible to always set the proportional gain KP to the minimum value. Therefore, the control gain decreases around the set injection pressure, and it is possible to prevent occurrence of oscillation in response.

The comparing module which compares a proportional gain that is calculated each time when the deviation δ1 is obtained with the proportional gain stored in the storage module, and uses the smaller proportional gain as a new proportional gain, and an input module which inputs the new control gain to the storage module are an example of means for comparing the proportional gain that is calculated each time when the deviation δ1 is obtained with the proportional gain stored in the storage module, and uses the smaller gain as a new proportional gain.

Besides, the pressure compensator 111 is provided with a storage module which stores the newest proportional gain, an update module which uses the proportional gain, which is obtained first after the set value of the injection pressure is changed, as a new proportional gain, and an input module which inputs the new proportional gain to the storage module. Thereby, when the set injection pressure is changed at a time during continuous injection molding is performed, it is possible to re-operate the proportional gain KP based on the new set injection pressure, and perform proper injection molding. The update module which uses the proportional gain, which is obtained first after the set value of the injection pressure is changed, as a new proportional gain, and an input module which inputs the new proportional gain to the storage module are an example of means for using the proportional gain, which is obtained first after the set value of the injection pressure is changed.

As described above, according to the molding machine controlling apparatus 100 of the present embodiment, an optimum control gain is used when pressure compensation is performed based on the deviation of the actual injection pressure from the set injection pressure, and thereby smooth injection pressure response is achieved.

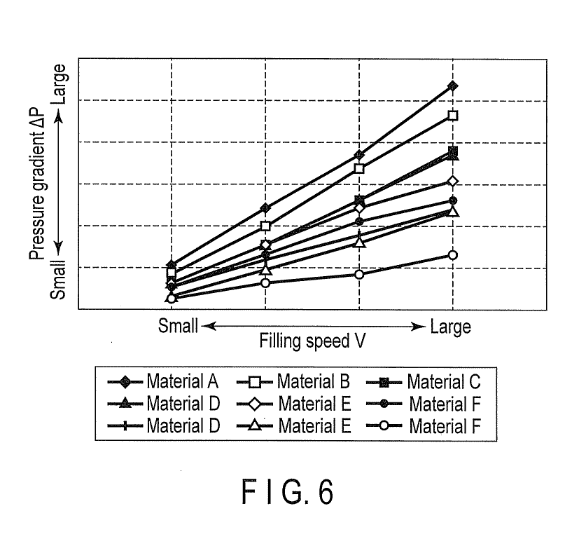

FIG. 6 is a graph illustrating relation between the actual injection speed V and the pressure gradient ΔP in various materials used for a method of controlling a molding machine 10 according to a second embodiment of the present invention.

FIG. 6 shows that the pressure gradient ΔP varies according to the difference in material, even when the actual injection speed V is the same. Specifically, even when the same pressure control is performed for the various materials, the pressure characteristic (pressure fluctuation) of the material is larger than the pressure characteristic of the reference material in the case where the material has pressure gradient larger than the pressure gradient of the reference material, and the pressure characteristic (pressure fluctuation) of the material is smaller than the pressure characteristic of the reference material in the case where the material has pressure gradient smaller than the pressure gradient of the reference material. The pressure gradient ΔP is one of physical characteristics (characteristics) of the material.

In addition, FIG. 6 also shows that the pressure gradient ΔP of the same material varies according to the difference of the actual injection speed V. Specifically, even when the same pressure control is performed for the same material, the pressure characteristic (pressure fluctuation) of the material is larger than the pressure characteristic at the reference filling speed in the case where the filling speed of the injection is higher than the reference filling speed of the injection, and the pressure characteristic (pressure fluctuation) of the material is smaller than the pressure characteristic at the reference filling speed in the case where the filling speed of the injection is lower than the reference filling speed of the injection.

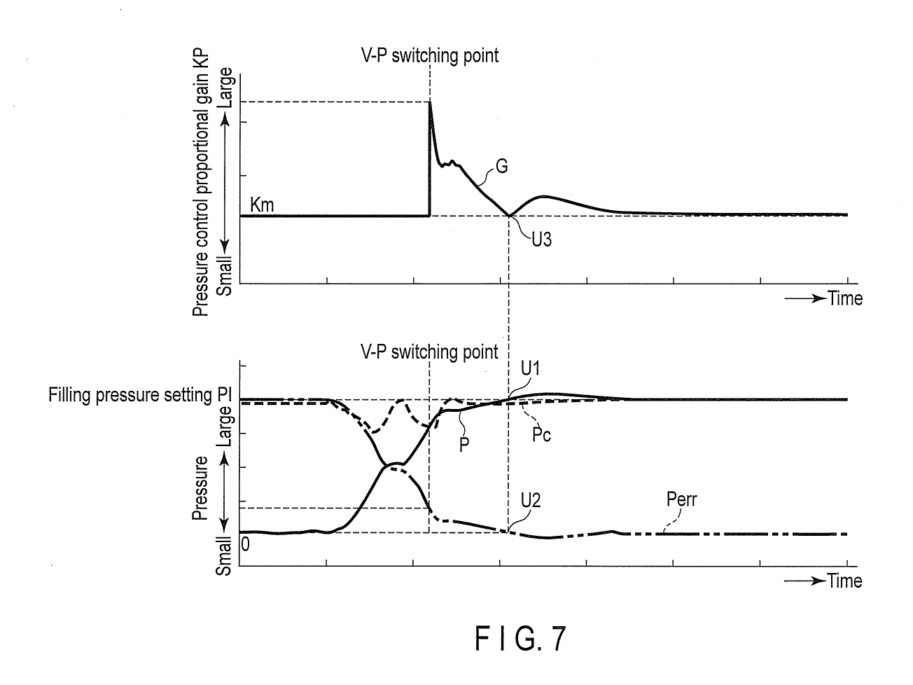

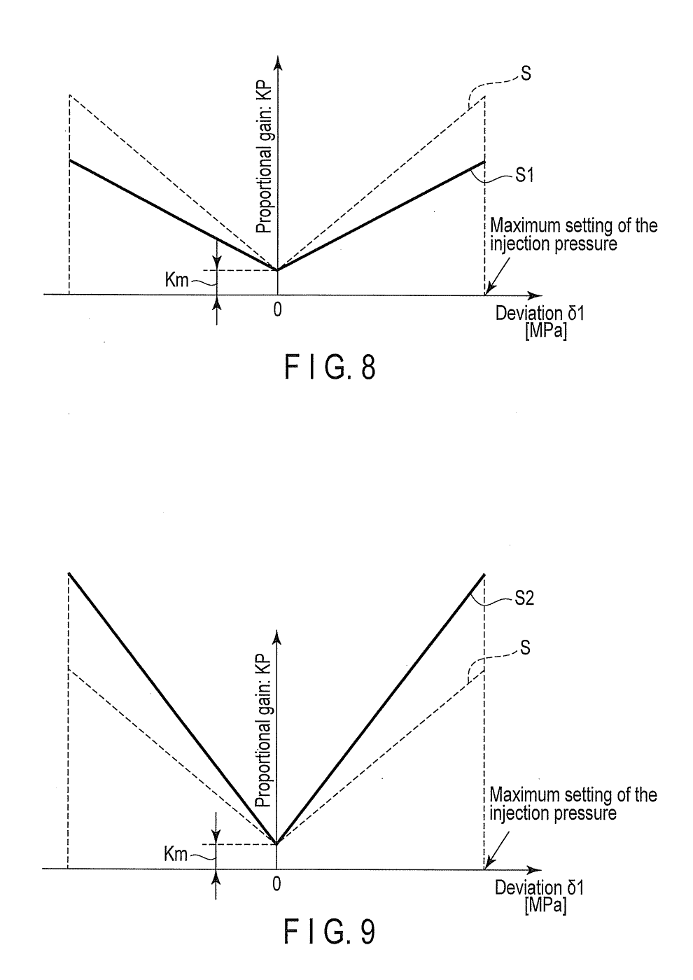

FIG. 7 is a graph illustrating change of the proportional gain KP with the lapse of time in the controlling method according to the second embodiment of the present invention, FIG. 8 is a graph illustrating setting of the proportional gain KP in the case where the pressure gradient ΔP of the filling material is larger than the pressure gradient of the reference material, and FIG. 9 is a graph illustrating setting of the proportional gain KP in the case where the pressure gradient ΔP of the filling material is smaller than the pressure gradient of the reference material.

In FIG. 7, the symbol P denotes change with the lapse of time of the filling pressure, the symbol Pc denotes change with the lapse of time of the V-P switching pressure, the symbol Perr denotes change with the lapse of time of the pressure deviation, the symbol G denotes change with the lapse of time of the pressure control proportional gain KP used for pressure control, the symbol U1 is a point in which the filling pressure first becomes equal to the filling pressure setting P1 during the filling operation, the symbol U2 is a point in which the filling deviation Perr first becomes 0 during the filling operation, and the symbol U3 denotes a pressure deviation proportional gain Km at the time when the pressure deviation Perr first becomes 0.

The pressure characteristic of the whole molding machine depends on the product of the pressure characteristic of the pressure control module and the pressure characteristic in the controlled object (such as the pressure characteristic (physical characteristic, characteristic) of the material, and pressure characteristic according to the shape of the mold and so on). Even when the pressure characteristic of the pressure control module is the same, the pressure characteristic of the whole molding machine is large when the pressure characteristic in the controlled object is large, and the pressure characteristic of the whole molding machine is small when the pressure characteristic in the controlled object is small.

According to the controlling method of the present embodiment, the proportional gain is calculated such that the pressure characteristic of the whole molding machine is fixed even when the pressure characteristic in the controlled object is changed. Specifically, when the pressure gradient ΔP is larger (the pressure characteristic is larger) than the pressure gradient of the reference material, the proportional gain KP is set smaller than the proportional gain of the reference material. In the same manner, when the pressure gradient ΔP is smaller than the pressure gradient of the reference material, the proportional gain KP is set larger than the proportional gain of the reference material.

In addition, as illustrated in FIG. 6, the rate of change of the proportional gain according to the material can be determined by a difference in the pressure gradient ΔP between the reference material and the other material, specifically, a ratio of the reference material to the other material for the pressure gradient ΔP. Specifically, the proportional gain in various materials is determined by multiplying the proportional gain for the reference material illustrated in FIG. 3 by the ratio of the reference material to the other material for the pressure gradient ΔP.

In addition, in the injection molding machine 10 according to the present embodiment, the storage module in the controlling apparatus 100 stores a correspondence table which shows relation between the injection speed for each material and the pressure gradient ΔP as illustrated in FIG. 6, such that the pressure gradient ΔP for each material in the same injection speed can be obtained. Therefore, when the reference material is specified, it is possible to calculate the pressure gradient ratio of each material for the reference material. The reference material is determined in advance by the manufacturer, and stored in the storage module of the controlling apparatus 100. As another example, the reference material is determined by the user, and stored in the storage module in the controlling apparatus 100 through an input device (not shown) by the user. Therefore, as illustrated in FIG. 8, in the case of using the material which has pressure gradient ΔP larger than the pressure gradient for the reference material, the proportional gain KP (S1 in FIG. 8) is smaller than the proportional gain (S in FIG. 8) for the reference material. As illustrated in FIG. 9, in the case of using the material which has pressure gradient ΔP smaller than the pressure gradient for the reference material, the proportional gain KP (S2 in FIG. 9) is larger than the proportional gain (S in FIG. 9) for the reference material. Therefore, since the proportional gain KP is calculated such that the pressure characteristic for the whole molding machine is fixed, the optimum proportional gain KP is set in the pressure control module, even when the pressure characteristic in the controlled object such as the material, the mold, and so on is changed.

As described above, since the proportional gain KP can be varied according to the physical characteristic (pressure characteristic, characteristic) of the material when the proportional gain is calculated, it is possible to use an optimum control gain for materials of various types.

In addition, an optimum proportional gain KP can be set for the filling material, by changing the proportional gain KP in accordance with the type of the material.

As described above, according to the injection molding machine controlling method of the present embodiment, it is possible to set an optimum proportional gain KP for the filling material, by calculating the proportional gain in accordance with the type of the material.

As described above, according to the present invention, an optimum control gain is used when the pressure compensation is performed based on a deviation of the actual injection pressure (actual measurement value of the injection pressure) from the set injection pressure (set value of the injection pressure), and thus smooth injection pressure response is achieved.

Although the first and second embodiments of the present invention adopt an injection apparatus in which one cylinder and a screw in the cylinder have both a plasticizing function and an injecting function, that is, one structure has both the plasticizing function and the injecting function, the present invention is not limited to it. For example, it is possible to use a preplasticating injection apparatus in which the plasticizing equipment is separated from the injecting equipment, that is, a plasticizing module is separated from an injecting module, an injection apparatus of a die-casting molding machine, an extruder of a plunger extrusion molding machine which performs extrusion operation by a plunger, or an extruder of an extrusion molding machine which uses both the screw system and the plunger system in combination.

In the preplasticating injection apparatus, the material is molten by a plasticizing module which performs plasticization, the material is moved to the injection module through a connecting module which connects the plasticizing module with the injection module, and injection operation of injecting the material is performed on the side of the injection module. The structure of the injection module is equipped, for example, a cylinder, a plunger (extruded member) inserted into the cylinder, a driving mechanism which advances and retreats the plunger, and so on.

The injection apparatus of a die-casting molding machine is equipped, for example, an injection module which includes an injection sleeve (cylinder) supplied with a molten material from a pouring equipment, an injection plunger (extruded member) inserted into the injection sleeve, a driving mechanism which advances and retreats the injection plunger, and so on. The injection operation is performed by extruding the material supplied into the injection sleeve by the injection plunger.

The extruder of the plunger extrusion molding machine is provided with (equipped), for example, a cylinder, a plunger (extruded member) inserted into the cylinder, a driving mechanism which advances and retreats the plunger, a material putting port formed in the cylinder, and so on. The material is put into the cylinder through the material putting port, and the material is injected by advancing the plunger.

The extruder of the extrusion molding machine using both the screw system and the plunger system in combination has a structure the screw device which performs plasticization is separated from the plunger device which performs injection, that is, the plasticizing module is separated from the injection module, like the preplasticating injection apparatus. The structure of the plunger device which performs injection includes, for example, a cylinder, a plunger (extruded member) inserted into the cylinder, a driving mechanism which advances or retreats the plunger, and so on.

The present invention may be carried out when the injection operation is performed by pushing out (advancing) the plunger or the injection plunger. Specifically, the controlling apparatus which performs injection by pushing out (advancing) the plunger or the injection plunger is provided with a pressure detector which detects pressure of the material in the cylinder, and a pressure compensator which compares a set value of a preset injection pressure with an actual measurement value of the injection pressure detected by the pressure detector in injection control, generates an injection speed command to the driving mechanism based on the comparison value, and varies the proportional gain based on a deviation of the actual measurement value of the injection pressure from the set value of the injection pressure. In addition, in the second embodiment, the proportional gain of the pressure compensator is varied (changed) also in accordance with the characteristic of the material. Thereby, it is possible to achieve smooth injection pressure response also in a preplasticating injection apparatus, an injection apparatus of a die-casting molding machine, an extruder of a plunger extrusion molding machine which performs injection operation by a plunger, or an extruder of an extrusion molding machine using both the screw system and the plunger system in combination, in the same manner as the first and second embodiments. Therefore, it is possible to achieve proper injection pressure response in injection molding, and achieve precisive molding. It is also possible to prevent occurrence of oscillations in response.

The function of the pressure compensator 111 is not obstructed by applying the present invention to a preplasticating injection apparatus, an injection apparatus of a die-casting molding machine, an extruder of a plunger extrusion molding machine which performs injection operation by a plunger, or an extruder of an extrusion molding machine using both the screw system and the plunger system in combination, but can be included in them like the first and second embodiments. Specifically, the function of the pressure compensator 111 is applicable to a preplasticating injection apparatus, an injection apparatus of a die-casting molding machine, an extruder of a plunger extrusion molding machine which performs injection operation by a plunger, or an extruder of an extrusion molding machine using both the screw system and the plunger system in combination, and thereby the same effect as the effect obtained by applying the above function of the pressure compensator 111 to the first and second embodiments is obtained also in a preplasticating injection apparatus, an injection apparatus of a die-casting molding machine, an extruder of a plunger extrusion molding machine which performs injection operation by a plunger, or an extruder of an extrusion molding machine using both the screw system and the plunger system in combination.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A controlling apparatus for a molding machine which advances and retreats an extruded member by a driving mechanism and performs injection, comprising:
a pressure detector which detects a pressure of a material in a cylinder; and
a pressure compensator which compares, in injection control, a preset value of an injection pressure with an actual measurement value of the injection pressure detected by the pressure detector, generates an injection speed command to the driving mechanism based on a comparison value, and varies a proportional gain based on a deviation of the actual measurement value of the injection pressure from the preset value of the injection pressure.

2. The controlling apparatus according to claim 1, wherein
the pressure compensator varies the proportional gain in accordance with a characteristic of the material.

3. A method of controlling a molding machine which advances and retreats an extruded member by a driving mechanism and performs injection, comprising:
detecting a pressure of a material in a cylinder;
comparing, in injection control, a preset value of an injection pressure with an actual measurement value of the injection pressure detected by the detecting;
compensating pressure by generating an injection speed command to the driving mechanism based on an obtained comparison value; and
varying a proportional gain based on a deviation of the actual measurement value of the injection pressure from the preset value of the injection pressure.

4. The method according to claim 3, wherein
the varying varies the proportional gain in accordance with a characteristic of the material.
